(19) United States
(12) Patent Application Publication
(10) Pub. No.: US 2018/0315422 A1
(43) Pub. Date: Nov. 1, 2018

(54) VOICE KEYWORD-BASED MULTIFUNCTIONAL SERVICE SYSTEM

(71) Applicant: BARO SERVICE CO.,LTD., Seoul (KR)

(72) Inventors: Jae Young JUNG, Seoul (KR); Yong Woo JEONG, Seoul (KR)

(73) Assignee: BARO SERVICE CO.,LTD., Seoul (KR)

(21) Appl. No.: 15/772,070

(22) PCT Filed: Oct. 28, 2016
(86) PCT No.: PCT/KR2016/012230

§ 371 Date: Apr. 29, 2018

(30) Foreign Application Priority Data
Oct. 30, 2015 (KR) 10-2015-0151810
Apr. 18, 2016 (KR) 10-2016-0047013

(51) Int. Cl. G10L 15/22; G06F 17/30; G06F 3/16

(52) U.S. Cl. CPC G10L 15/22; G10L 2015/223; G06F 3/167; G06F 17/30663

(57) ABSTRACT

Disclosed is a voice keyword-based multifunctional service system according to an embodiment of the present invention, the system comprising: a smart phone capable of receiving an input of a voice; and a smart phone capable of receiving an input of a voice, wherein the multifunctional server system provides a content corresponding to the keyword to the smart phone with reference to a keyword information DB—a database in which keyword information is pre-stored—, and a multifunctional service application installed in the smart phone performs an operation of executing the content corresponding to the keyword

### TECHNICAL FIELD

The present invention relates to a voice keyword-based multifunctional service system, and an application (computer programs) and multifunctional server system used for a voice keyword-based multifunctional service system.

### RELATED ART

In recent years, more and more businesses run their advertisements. Accordingly, people are exposed to advertisements of KyoChon F&B, Goobne, Nene Chicken, PizzaHut, Dominos, Industrial Bank of Korea, WOORI BANK, Samsung Electronics, Hyundai Motor Company, Mcdonalds etc. dozens of times or hundreds of times a day.

Such companies pour much money into advertising every year. However, people do not remember the phone numbers or the homepage addresses of those companies.

Accordingly, needed is a service system capable of providing keywords advertisers want and content of services (e.g. making calls, accessing homepages, executing programs etc.) corresponding to the keywords.

### DETAILED DESCRIPTION OF THE INVENTION

### Technical Problems

According to one or more embodiments of the present invention, provided is a voice keyword-based service system in which if a voice keyword is input to a smartphone, a multifunctional service application (BARO app) installed on the smartphone is linked with a multifunctional server system to execute content corresponding to the voice keyword.

### Technical Solutions

A voice keyword-based multifunctional service system according to an embodiment of the present invention includes a smartphone into which a voice is input; and a multifunctional server system for performing operations of receiving voice data from the smartphone and of generating a keyword from the voice data transmitted by the smartphone, the multifunctional server system performs an operation of providing content corresponding to a keyword to the smart phone with reference to a keyword information DB—a database in which the keyword information is pre-stored—, and a multifunctional service application installed on the smart phone performs an operation of executing the content corresponding to the keyword.

According to an embodiment of the present invention, provided is a computer-readable recording medium in which recorded is a voice keyword-based multifunctional service application for executing a method for a voice keyword-based multifunctional service, wherein the multifunctional service application is combined with hardware provided to a smartphone and linked to a multifunctional server system to execute the method for a voice keyword-based multifunctional service, and the method for a multifunctional service includes receiving a voice (step A); converting the voice into digital data and transmitting the converted voice data to the multifunctional server system (step B); receiving content corresponding to a keyword generated from the voice data from the multifunctional server system (step C); and executing the content corresponding to the keyword (step D).

According to an embodiment of the present invention, provided is a computer-readable recording medium in which recorded is a voice keyword-based multifunctional service program for executing a method for a voice keyword-based multifunctional service, wherein the multifunctional service program is combined with hardware provided to a multifunctional server system and linked to a smartphone to execute the method for a voice keyword-based multifunctional service, and the method for a multifunctional service includes receiving voice data from the smartphone (step A); generating a keyword from the received voice data (step B); and providing to the smartphone content corresponding to the keyword with reference to a keyword information DB—a database in which keyword information is pre-stored—(step C).

### Advantageous Effects

According to one or more embodiments of the present invention, provided is a voice keyword-based multifunctional service system capable of executing content (e.g. calling, accessing a web server, or executing an application program installed on a smartphone) corresponding to a voice keyword pre-stored by an advertiser even when a user just says the voice keyword.

### BRIEF DESCRIPTION OF THE DRAWINGS

FIGS. 1 to 3 are views illustrating elements and operations of a voice keyword-based multifunctional service system according to an embodiment of the present invention.

FIG. 4 is a view illustrating a voice keyword-based multifunctional service system according to another embodiment of the present invention.

FIGS. 5 to 7 are views illustrating a voice keyword-based multifunctional service system according to another embodiment of the present invention.

### DESCRIPTION OF SYMBOLS

1, 101, 201: Smartphone 3, 103, 203: Microphone
5, 105, 205: Multifunctional service application (BARO app)
7, 207: Calling program 9, 109, 209: Speaker
11, 111, 211: Voice recognition server 13, 113, 213: Subsequent process server
15, 115, 215: Multifunctional service server 21, 121, 221: ARS information DB
23, 123, 223: Call relay information DB 25, 125, 225: App information DB
27, 127, 227: Keyword information DB

### BEST MODE FOR CARRYING THE INVENTION

Objects, other objects, features and advantages of the present invention will be easily understood on the basis of the description of the preferred embodiments that will be described hereunder in relation to the attached drawings. The invention, however, may be embodied in various different forms, and should not be construed as being limited only to the illustrated embodiments. Rather, these embodiments are provided as examples so that this disclosure will be thorough and complete and that the technical ideas of the invention will be fully conveyed to those skilled in the art.

Throughout the specification, the wording of “transmit”, “communicate”, “send”, “receive” signals or information and “the like with similar meanings thereof” means that one element directly delivers signals or information to another element and also means that one element delivers signals or information to another element through a third element. In particular, in the wording that a signal or information is “transmitted” or “sent” to one element, one element indicates a final destination of the signal or information, but not a direct destination thereof. The same is true of the wording of “receive” signals or information.

It will be understood that, although terms “first”, “second”, etc., are used herein to describe various elements, these elements should not be limited by these terms. These terms are used only to distinguish one element from another element. The embodiments illustrated and set forth herein include their complementary ones.

The terminology set forth herein is used only to describe embodiments and is not intended to limit the present invention. As used herein, the singular forms “a”, “an” and “the” are intended to include the plural forms as well, unless clearly indicated otherwise.

Throughout the specification, the wording “comprise” and/or “comprising” will be understood to imply the inclusion of stated elements but not the exclusion of any other element.

Here under, the invention will be described in detail by referring to the attached drawings. In describing the particular embodiments that will be described hereunder, various particulars are provided to describe the invention in more detail and to enhance understanding of the invention. However, it will become apparent to readers who have enough knowledge to understand the art to which the invention pertains that the invention may be used without the particulars. In some cases, in describing the invention, detailed descriptions of the things that are well-known and are not closely related to the invention will be omitted if they are deemed to make the gist of the present invention unnecessarily vague.

A voice keyword-based multifunctional service system according to an embodiment of the present invention includes a smartphone for receiving a voice; and a multifunctional server system performing operations of receiving voice data from the smartphone and of generating a keyword from the voice data transmitted by the smartphone, the multifunctional server system performs operations of providing “content corresponding to the keyword” to the smart phone with reference to a keyword information DB—a database in which keyword information is pre-stored—, and a multifunctional service application installed on the smart phone performs an operation of executing the “content corresponding to the keyword”.

Herein, the “content corresponding to the keyword” includes at least one of phone numbers, URLs used to access web servers, program package names used to execute programs.

The operation of executing the content corresponding to the keyword includes executing a calling program and performing an operation, carried out by the executed calling program, of calling a call process server having a phone number in the event that the content corresponding to the keyword is a phone number of a call process server.

The operation of executing the content corresponding to the keyword includes executing a web browser and performing an operation, carried out by the executed web browser, of accessing a web server having a URL in the event that the content corresponding to the keyword is a URL of a web server.

The operation of executing the content corresponding to the keyword includes executing a program having a program package name in the event that the content corresponding to the keyword is a program package name.

The operation of executing the content corresponding to the keyword includes executing a calling program and performing an operation, carried out by the executed calling program, of calling a call process server having a phone number in the event that the content corresponding to the keyword is a phone number of a call process server.

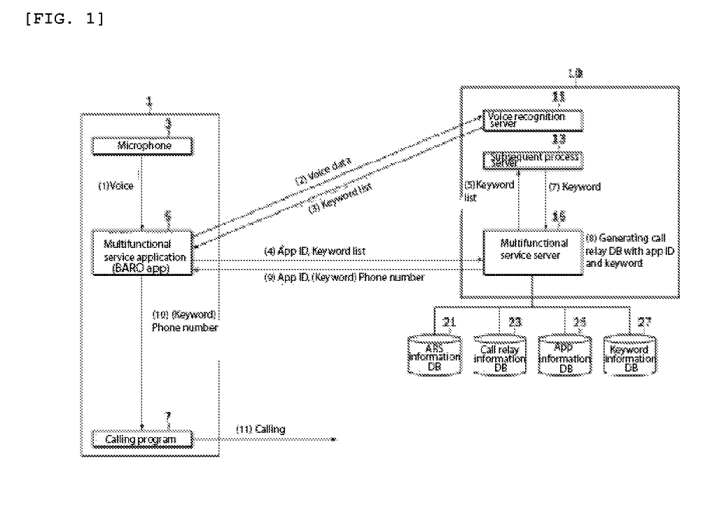

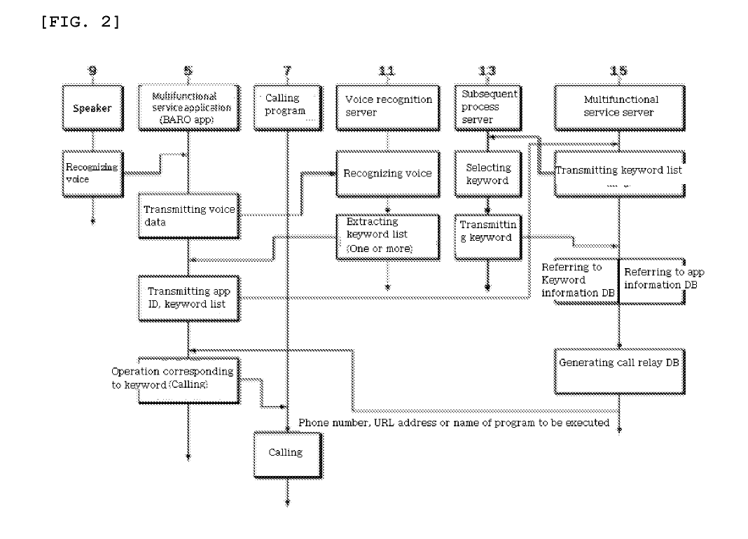

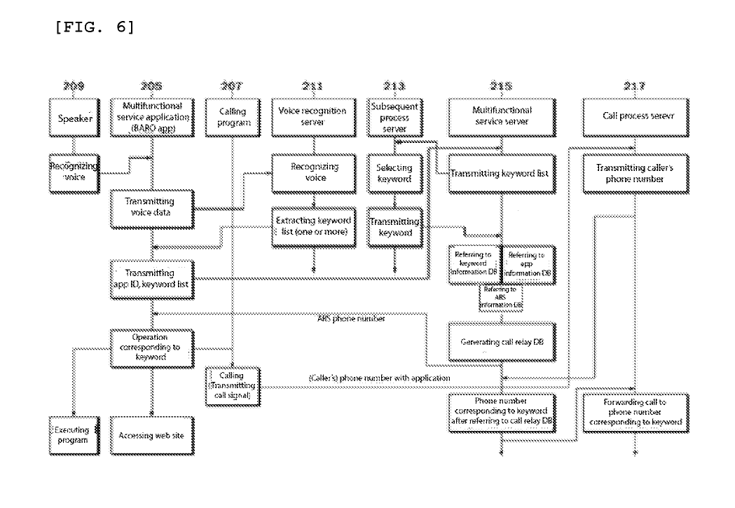

Meanwhile, by referring to FIGS. 1 to 7, a voice keyword-based multifunctional service system according to various embodiments of the present invention will be described together with the functions of the elements commonly included in the embodiments, and other elements performing different functions will be described in detail by referring to the relevant drawings.

By referring to FIGS. 1 to 7, a voice keyword-based multifunctional service system according to an embodiment of the present invention includes a smartphone 1, 101, 201 and a multifunctional server system 100, 200, 300. Meanwhile, the multifunctional server system 100, 200, 300 includes one or more servers and DBs. Herein, one or more of the servers may be voice recognition servers, subsequent process servers, multifunctional service servers, call process servers, and the DBs include ARS Information DBs 21, 121, 221, app information DBs 25, 125, 225 and keyword information DBs 27, 127, 227. Herein, applications are often referred to as apps, and through the specification, “applications” denotes “apps”.

The smartphone 1, 101, 201 may include programs including a voice keyword-based multifunctional service application 5, 105, 205 according to an embodiment of the present invention, a calling program 7, a web browser 109 and an operating system (invisible), a microphone 3, 103, 203 for receiving a voice input by a user and a speaker 9, 209 for outputting the voice input by the user.

Herein, the multifunctional service application 5, 105, 205 refers to a voice keyword-based multifunctional service application for providing a voice keyword-based multifunctional service, and is also referred to as “BARO app” in this specification.

The execution of the multifunctional service application 5, 105, 205 according to an embodiment of the present invention leads to the activation of a microphone 3, 103, 203 and speaker 9, 209. For instance, if the multifunctional service application 5, 105, 205 needs to receive a voice input by a user, the multifunctional service application 5, 105, 205 activates the microphone 3, 103, 203 such that the microphone 3, 103, 203 may sense (detect) the voice.

The multifunctional server system 10, 100, 200 may include a program download server (invisible) that stores and manages apps according to an embodiment of the present invention and that if the smartphone requests the program download server to download, the program download server transmits the apps to the smartphone, a voice recognition server 11, 211, 311 for converting voice into text, a web server (invisible) for providing web servers, a multifunctional service server 15, 115, 215 for providing multifunctional services of the present invention, a subsequent process server 13, 113, 213 and a call process server 217. The function of each of the servers will be described hereunder in detail.

The apps installed on the smartphone 1, 101, 201 are linked to the multifunctional server system 10, 100, 200 to operate, the calling program performs an operation of calling, and a web browser accesses a web server to display web servers provided by the web server in the way in which the user may see the web servers.

An ARS information DB 21, 121, 221 stores data necessary for the operation of ARS connection such as one or more ARS phone numbers corresponding to each telecommunications service provider and the availability thereof etc., and an APP information DB 25, 125, 225 stores data in relation to a user who installed a multifunctional service application 5, 105, 205 such as phone numbers with the multifunctional service application 5, 105, 205, the user's ID, the user's name, the ID of the multifunctional service application 5, 105, 205 etc.

Herein, the multifunctional service application ID denotes an application ID driven for processing certain data on the smartphone 1, 101, 201, and the multifunctional service application ID may include the name, abbreviation, code number etc. of an application, That is, the multifunctional service application ID is only to specify the multifunctional service application.

The keyword information DB 27, 127, 227 pre-stores a keyword necessary for executing the multifunctional service application 5, 105, 205 and types of services, content of services, communications service providers, types of business, types of communication etc. corresponding to the keyword.

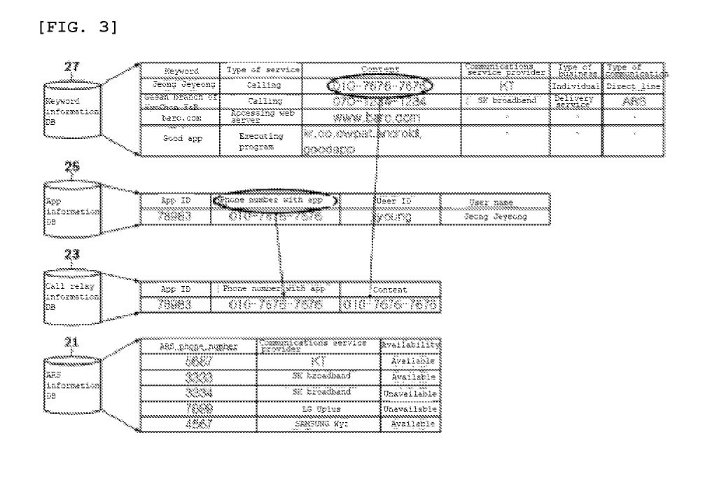

By referring to FIG. 3, types and content of services corresponding to a keyword are determined by the user who registers the keyword, and in this embodiment, only one of the following operations of “calling”, “accessing a website” or “executing a program” may be performed through the keyword stored in the keyword information DB 27.

For instance, if “Jeong Jaeyoung” is registered as a keyword for the first time, “calling” is registered as a service corresponding to the keyword, and a “phone number” used for calling is registered as content corresponding to the keyword, the operation of calling is performed. If “baro.com” is registered as a keyword, “accessing a web server” is registered as a service corresponding to the keyword, and a “URL address” used for accessing a web server is registered as content corresponding to the keyword, the operation of accessing a web server with the registered URL address is performed.

Further, if “GOOD app” is registered as a keyword, “executing a program” is registered as a service corresponding to the keyword, and a “program package name” is registered as content corresponding to the keyword, the operation of executing the registered program package name is performed.

That is, operations corresponding to the keywords of “Jeong Jaeyoung” and “baro.com” may differ according to the registered operations corresponding to the keywords.

Data stored in the ARS information DB, the app information DB, the keyword information DB may be stored in the multifunctional server system 10, 100, 200, or in an arbitrary storage device (computer-readable recording medium) connected through a communication network such that the multifunctional sever system may access and obtain the data anytime

Further, the operations performed on the smartphone 1, 101, 201 may be performed by the multifunctional service application 5, 105, 205 installed on the smartphone 1, 101, 201, and the operations performed by the multifunctional server system 10, 100 may be performed by the multifunctional service program installed on the multifunctional server system 10, 100.

Meanwhile, the above-described multifunctional service application is combined and linked with hardware of the smartphone 1, 101, 201 to operate, and the multifunctional service program is also combined and linked with hardware of the multifunctional server system 10, 100 to operate.

The multifunctional service application 5, 105, 205 according to the present invention may be embodied in the form of various program instructions for executing the method for a multifunctional service performed on the above-described smartphone 1, 101, 201 to be recorded on computer-readable recording media.

The computer-readable medium may independently include program instructions, data files, data structures etc. or a combination thereof. The program instructions recorded on the medium may be specially designed and configured for the present invention or the program instructions that are well-known to those skilled in the art relating to computer software programs may be used. The examples of computer-readable recording media include magnetic media such as hard disks, floppy disks and magnetic tape, optical media such as CD-ROMs and DVDs, magneto-optical media such as floptical disks, and hardware devices that are specially configured to store and perform program instructions such as Read Only Memory (ROM), Random Access Memory (RAM) and flash memory etc. The examples of program instructions include not only machine language code produced by a compiler but also high-level language code executed by the computer through an interpreter etc.

The above-described elements, operations and data will be included in the detailed description of this specification.

FIGS. 1 to 3 are views illustrating elements and operations of a voice keyword-based multifunctional service system according to an embodiment of the present invention, and the order of each of the operations is indicated by numbers or arrows.

By referring to FIGS. 1 to 3, a voice keyword-based multifunctional service system according to an embodiment of the present invention includes a smartphone 1 and a multifunctional server system 10, and the multifunctional server system 10 includes a voice recognition server 11, a subsequent process server 13, a multifunctional service server 15 and DBs 21, 23, 25, 27.

By referring to FIGS. 1 to 3, the execution of a multifunctional service application 5 leads to the activation of the microphone 3 of the smartphone 1. That is, when the microphone 3 is activated, the microphone is ready to receive a voice keyword input by a user (step 1 in FIG. 1).

When the smartphone 1 receives a voice keyword as an analogue signal through the microphone 3, the analog signal is converted into digital data through an A/D converter (invisible) provided to the smartphone 1. In this specification, the digital data converted from the analog signal is referred to as “voice data”.

The smartphone 1 transmits the voice data to the multifunctional server system 10, and the multifunctional server system 10 performs an operation of generating a keyword from the voice data.

Herein, the operation of generating a keyword denotes operations of analyzing the voice data transmitted by the smartphone 1 and converting the voice data into a text, and the text may include one or more texts. That is, a “keyword list” denotes one or more texts converted from the voice data. The operation of generating a keyword includes generating such a keyword list or selecting a keyword from the generated keyword list.

According to an embodiment of the present invention, the smartphone 1 transmits the voice data to the voice recognition server 11 (step 2 in FIG. 1), and the voice recognition server generates a keyword list to transmit the keyword list to the smartphone 1 (step 3 in FIG. 1). For instance, if the voice data are “Jeong Jeyeong”, the voice recognition server 11 analyzes the voice data and generates one or more keyword lists such as “Jeong Jeyeong”, “Jeong Jaeyeong” “fang Jaeyeong” etc. to transmit the keyword lists to the smartphone 1.

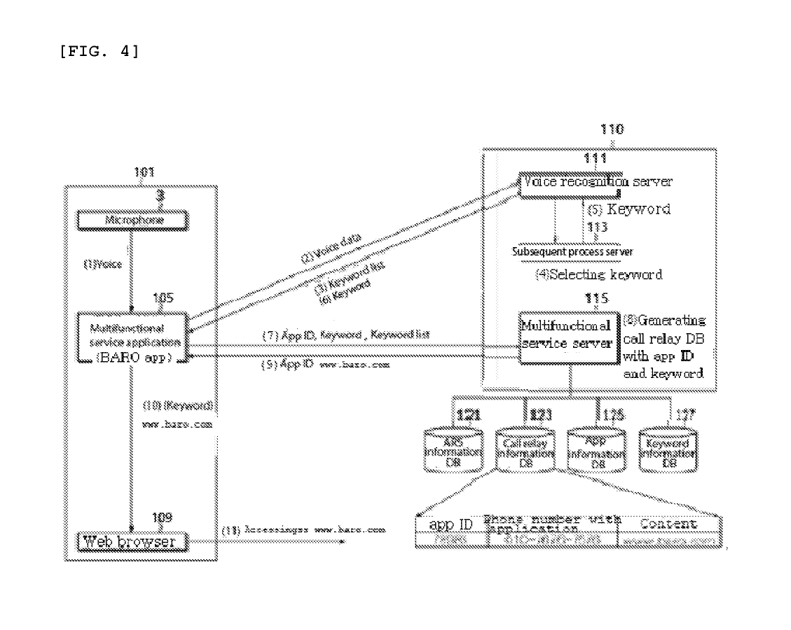

According to another embodiment of the present invention, the voice recognition server 11 may also generate the keyword list and analyze the keyword list to select a keyword corresponding to the voice data and then, transmit the keyword to the smartphone 1. The details related to this will be described hereunder by referring to FIG. 4.

The smartphone 1 transmits the keyword list received from the voice recognition server 11 to the multifunctional server system 10, and at the same time, the smartphone 1 may also transmit a multifunctional service application ID (“app ID”). In another way, the smartphone 1 may transmit to the multifunctional server system 10 the keyword list together with the multifunctional service application ID and the voice data.

For instance, the multifunctional server system 10 receiving the keyword list and the multifunctional service application ID may be a multifunctional service server 15, and the smartphone 1 may transmit the keyword list and the multifunctional service application ID to the multifunctional service server 15 (step 4 in FIG. 1). The multifunctional service server 15 may transmit to a subsequent process server the keyword list or the keyword list together with the voice data transmitted by the smartphone 1 (step 5 in FIG. 1).

The subsequent process server 13 analyzes the keyword list received from the multifunctional service server 15 to select a keyword corresponding to the voice data (step 6 in FIG. 1). If the subsequent process server 13 receives the keyword list together with the voice data from the multifunctional service server 15, the subsequent process server 13 may select a keyword with reference to the voice date.

The subsequent process server 13 analyzes the keyword list and selects a keyword corresponding to the voice data to transmit the keyword to the multifunctional service server 15 (step 7 in FIG. 1). For instance, if “Jeong Jeyeong” out of the above-described keyword list is selected as a keyword corresponding to the voice data, the subsequent process server transmits the keyword of “Jeong Jeyeong” to the multifunctional service server 15.

The multifunctional server system 10 may generate a call relay information DB 23 used for relaying a call with reference to a keyword information DB 27, the multifunctional service application ID and the keyword provided by the smartphone 1.

For instance, the multifunctional server system 10 generating the call relay information DB 23 may be the multifunctional service server 15, and the multifunctional service server 15 may store content corresponding to the keyword in the call relay information DB 23 with reference to the multifunctional service application ID, an app information DB 25, a phone number with an application corresponding to the multifunctional service application ID and the keyword information DB 27 (step 8 of FIG. 1).

According to an embodiment of the present invention, a method in which the multifunctional server system 10, as a multifunctional service server 15, generates the call relay information DB 23 will be described in detail by referring to FIG. 3.

By referring to FIG. 3, the call relay information DB 23 according to an embodiment of the present invention includes an app ID, a phone number with an app, and content of a keyword. Herein, the phone number with an app is the phone number of a smartphone with a multifunctional service application installed on it.

By referring to FIG. 3, according to this embodiment, if the multifunctional service server 15 receives the keyword of “Jeong Jeyeong” from the subsequent process server 13, a phone number (010-7676-7676), as content corresponding to the keyword of “Jeong Jeyeong”, is pre-stored in the keyword information DB so as to relay the service of “calling” which is registered as a desired service when the keyword of “Jeong Jeyeong” is registered, and the multifunctional service server 15 stores in the call relay information DB 23 the content—i.e. the phone number “010-7676-7676”—corresponding to the keyword of “Jeong Jeyeong” with reference to the keyword information DB 27.

Further, in order to relay the service of “calling” which is registered as a desired service when the keyword of “Jeong Jeyeong” is registered, the multifunctional service server 15 may store in the call relay information DB 23 a phone number (e.g. 010-7676-7676) with an application, which is related to an application ID (app ID 78983) corresponding to the multifunctional service application ID (app ID 78983), with reference to the app information DB 25 in which the multifunctional service application ID is stored.

The multifunctional service application 5 may relay a call by using a phone number with the multifunctional service application 5 stored in the above-described call relay information DB 23 and a phone number as content corresponding to a keyword, and the details related to this will be described hereunder.

According to an embodiment of the present invention, after generating a call relay information DB 23, the multifunctional server system 10 provides to the smartphone 1 a multifunctional service application ID and content corresponding to a keyword. The smartphone 1 may perform an operation of executing the content corresponding to the keyword when receiving the multifunctional service application ID and the content corresponding to the keyword from the multifunctional server system 10.

Herein, the content corresponding to the keyword may include one more of phone numbers, URLs used to access web servers, and program package names used to execute the programs.

For instance, as illustrated in FIG. 1, the multifunctional service server 15 of the multifunctional server system 10 may provide to the smartphone 1 a multifunctional service application ID and content corresponding to a keyword. In this embodiment, if content corresponding to a keyword is a phone number of a call process server, the multifunctional service server 15 transmits to the smartphone 1 a multifunctional service application ID, instructions to perform an operation of “calling”, and a phone number (step 9 in FIG. 1). In the event that the smartphone 1 receives the instructions to perform an operation of “calling” and the phone number from the multifunctional service server 15, the operation of executing the content corresponding to the keyword includes executing a calling program 7 on the smartphone 1, transmitting the phone number to the calling program 7 by the multifunctional service application 5 (step 10 in FIG. 1), and calling a call process server having the phone number by the executed calling program 7 (step 11 in FIG.

Here's another example. If content corresponding to a keyword is a URL used to access a web server, the multifunctional server system 10 transmits to the smartphone 1 instructions to perform an operation of “accessing a web server”, and a web server address. In the event that the smartphone 1 receives the instructions to perform an operation of “accessing a web server” and a web server address from the multifunctional server system 10, the operation of executing the content corresponding to the keyword includes executing a web browser by the multifunctional service application 5 and accessing a web server having the URL by the executed web browser (FIG. 4).

Here's yet another example. If content corresponding to a keyword is a program package name, the multifunctional server system 10 transmits to the smartphone 1 instructions to perform an operation of “executing a program” and a “program package name which will be executed”. In the event that the smartphone 1 receives the instructions to perform an operation of “executing a program” and “a program package name which will be executed” from the multifunctional server system 10, the operation of executing the content corresponding to the keyword performed by the multifunctional service application 5 includes executing a program having the program package name. If the program indicated by the program package name which will be executed is not installed on the smartphone 1, the user needs to download and execute the program indicated by the program package name which will be executed by accessing a program download server.

FIG. 4 is a view illustrating a voice keyword-based multifunctional service system according to another embodiment of the present invention, and the order of each of the operations is indicated by numbers or arrows.

By referring to FIG. 4, a voice keyword-based multifunctional service system according to an embodiment of the present invention includes a smartphone 101 and a multifunctional server system 110, and the multifunctional server system 110 includes a voice recognition server 111, a subsequent process server 113, a multifunctional service server 115 and DBs 121, 123, 125, 127.

The embodiments of FIGS. 1 to 3 and the embodiment of FIG. differ only in the operation of generating a keyword. Hereunder, the difference will be described.

By referring to FIG. 4, the execution of a multifunctional service application 105 leads to the activation of the microphone 103 of the smartphone 101, and the microphone is ready to receive a voice keyword input by a user (step 1 in FIG. 4).

The smartphone 101 transmits to a voice recognition server 111 voice data, which denote digital data converted from the voice keyword (step 2 in FIG. 4), and the voice recognition server 111 performs an operation of generating a keyword from the voice data.

Herein, the operation of generating a keyword includes analyzing voice data transmitted by the smartphone 101 and converting the voice data into a text, and the text may include one or more texts. That is, a “keyword list” denotes one or more texts converted from the voice data. The operation of generating a keyword includes generating such a “keyword list” or selecting a keyword from the generated keyword list.

According to an embodiment of the present invention, the voice recognition server 111 may perform an operation of generating a keyword list, and a subsequent process server 113 may perform an operation of selecting a keyword.

For instance, if voice data are “baro.com”, the smartphone 101 transmits the voice data to a voice recognition server 111 (step 2 in FIG. 4), and the voice recognition server 111 analyzes the voice data and generates one or more keyword lists to transmit the keyword lists to the smartphone 111 (step 3 in FIG. 4).

If the voice recognition server 111 transmits the keyword lists to the smartphone 101 and at the same time, or afterwards, the smartphone 101 transmits the keyword lists to a subsequent process server 113, the subsequent process server 113 analyzes the keyword lists to select a keyword corresponding to the voice data (step 4 in FIG. 4). In another way, the voice recognition server 111 may transmit to the subsequent process server 113 the voice data together with the keyword lists. In this case, the subsequent process server 113 may select a keyword with reference to the voice data.

The keyword selected by the subsequent process server 113 is transmitted to the voice recognition server 111 (step 5 in FIG. 4), and the voice recognition server 111 may provide the transmitted keyword to the smartphone 101 (step 6 in FIG. 4). For instance, if the subsequent process server 113 selects “baro.com” as a keyword corresponding to the voice data among the keyword list, the subsequent process server transmits the keyword of “baro.com” to the voice recognition server 111, and the voice recognition server 111 provides the keyword of “baro.com” to the smartphone 101.

The smartphone 101 may transmit the keyword list, or the keyword list and a multifunctional service application ID, provided by the voice recognition server 111, to a multifunctional service server 115 (step 7 in FIG. 4).

The multifunctional service server 115 may generate a call relay information DB 123 with reference to the keyword, a keyword information DB 127 and the multifunctional service application ID, provided by the smartphone 101 (step 8 in FIG. 4).

For instance, the multifunctional service server 115 generating the call relay information DB 123 may store in the call relay information DB 123 a phone number (e.g. 010-7676-7676) with an application, which is related to an application ID (app ID 78983) corresponding to the multifunctional service application ID (app ID 78983), with reference to an app information DB 125 in which the multifunctional service application ID is stored.

Further, when “baro.com” is registered as a keyword, the multifunctional service server 125 stores in the call relay information DB 123 content corresponding to the keyword of “baro.com”, i.e. a URL (www.baro.com) with reference to the keyword information DB 127 because the URL (e.g. www.baro.com) used to access a web server is pre-stored in the keyword information DB 127 as the content corresponding to the keyword of “baro.com”.

By referring to FIG. 4, after generating the call relay information DB 123, the multifunctional service server 115 transmits to the smartphone 101 the multifunctional service application ID and the content corresponding to the keyword, i.e. instructions to perform an operation of “accessing a web server” and the URL (www.baro.com) (step 9 in FIG. 4).

In the event that the smartphone 101 receives the instructions to perform an operation of “accessing a web server” and the URL (www.baro.com) from the multifunctional service server 115, the operation of accessing the URL (www.baro.com) includes executing a web browser 109 on the smartphone 101, transmitting the URL (www.baro.com) to the web browser 109 (step 10 in FIG. 4) by the multifunctional service application 105 and accessing the web server having the URL, i.e. www.baro.com by the executed web browser 109 (step 11 in FIG. 4).

In this embodiment, a URL used to access a web server has been described as content corresponding to a keyword. In other ways, a phone number of a call process server or a program package name may be embodied as content corresponding to a keyword.

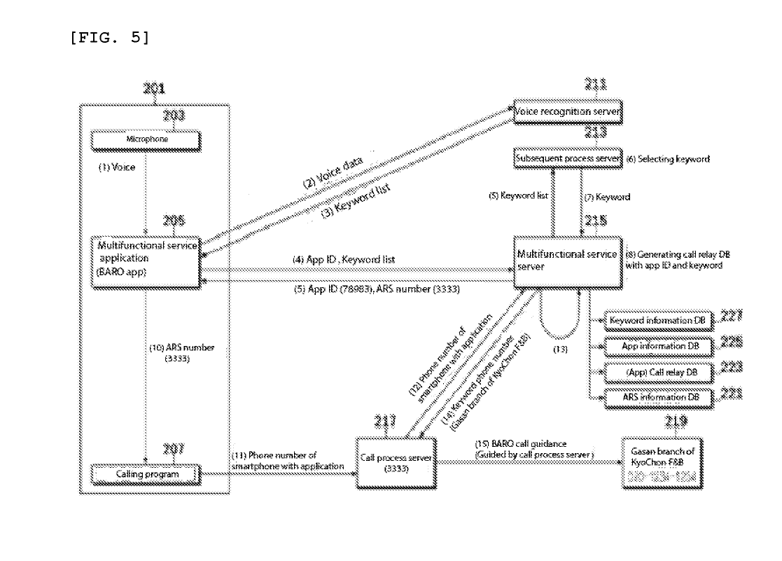

FIGS. 5 to 7 are views illustrating a voice keyword-based multifunctional service system according to another embodiment of the present invention, and the order of each of the operations is indicated by numbers or arrows.

By referring to FIGS. 5 to 7, a voice keyword-based multifunctional service system according to an embodiment of the present invention includes a smartphone 201 and a multifunctional server system 210, and the multifunctional server system 210 includes a voice recognition server 211, a subsequent process server 213, a multifunctional service server 215, a call process server 217 and DBs 221, 223, 225, 227.

The embodiments of FIGS. 1 to 3 and the embodiments of FIGS. 5 to 7 differ only in that a multifunctional server system in the embodiments of FIGS. 5 to 7 includes a call process server 217 and that in the event that the content corresponding to the keyword is a “phone number of a call process server”, the call process server 217 transmits to the smartphone 201 a multifunctional service application ID together with an ARS number for forwarding a call at a phone number of the call process server. That is, steps from 1 to 7 illustrated in FIG. 5 and the embodiments illustrated in FIGS. 1 to 3 are the same, and steps from 8 to 15 illustrated in FIG. and the embodiments illustrated in FIGS. 1 to 3 are different. Accordingly, the difference will be described hereunder.

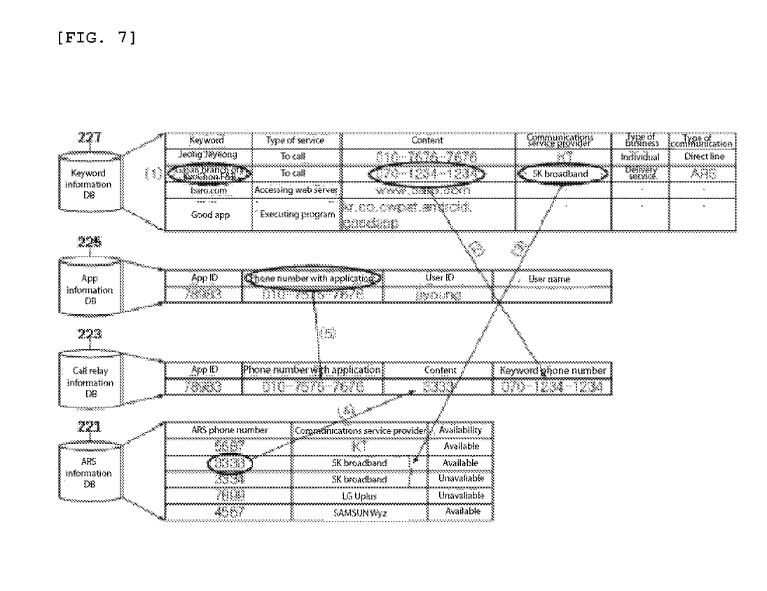

In the event that the multifunctional server system is a multifunctional service server 215, and that “Gasan branch of KyoChon F&B” is a keyword, a method for generating a call relay information DB 223 according to an embodiment of the present invention will be described By referring to FIG. 7.

When “Gasan branch of KyoChon F&B” is registered as a keyword, (step 1 in FIG. 7), the multifunctional service server 225 stores in the call relay information DB 223 content corresponding to the keyword of “Gasan branch of KyoChon F&B”, i.e. a phone number (070-1234-1234) of a call process server as a “keyword phone number” with reference to a keyword information DB 227 because the phone number (070-1234-1234) of the call process server is pre-stored in the keyword information DB 227 as the content corresponding to the keyword of “Gasan branch of KyoChon F&B” (step 2 in FIG. 7).

In the event that the content corresponding to the keyword of “Gasan branch of KyoChon F&B” is a phone number of a call process server, the multifunctional service server 215 refers to SK broadband as information on a communications service provider of “Gasan branch of KyoChon F&B” in the keyword information DB 227, and then, refers to one or more ARS phone numbers and the availability thereof corresponding to SK broadband in an ARS information DB 221 and afterwards, selects an ARS phone number SK broadband is not using (e.g. 3333) and stores the ARS phone number as “content corresponding to the keyword” in the call relay information DB 223 (step 4 in FIG. 7).

Further, the multifunctional service server 215 may store in the call relay information DB 223 a phone number (e.g. 010-7676-7676) with an application, which is related to an application ID (app ID 78983) corresponding to a multifunctional service application ID (e.g. app ID 78983), with reference to an app information DB 225.

Regardless of the order of steps 2 to 5 in FIG. 7, any one of the steps may be carried out first to generate the call relay information DB 223.

After generating the call relay information DB 223, the multifunctional service server 215 provides to the smartphone 201 the multifunctional service application ID and the content corresponding to the keyword. In this embodiment, because the content corresponding to the keyword of “Gasan branch of KyoChon F&B” is a “phone number of a call process server”, the multifunctional service server 215 transmits to the smartphone 201 the multifunctional service application ID (app ID 78983), instructions to perform an operation of “calling” and an ARS number (3333) for forwarding a call at a phone number of a call process server (step 9 in FIG. 5).

In the event that the smartphone 201 receives the instructions to perform an operation of “calling” and the ARS number (3333) from the multifunctional service server 215, the operation of executing the content corresponding to the keyword performed by a multifunctional service application 205 is included in steps 10 to 15 in FIG. 5 and will be described as follows.

The multifunctional service application 205 executes a calling program 207 and provides the ARS number (3333) to the calling program (step 10 in FIG. 5), the executed call program 207 also provides the phone number thereof (i.e. a phone number of a smartphone 201 with the multifunctional service application installed on it) while calling a call process server 217 having the ARS number (3333) (step 11 in FIG. 5). When receiving a call from the smartphone 201 with the multifunctional service application installed on it through the calling program 207, the call process server 217 transmits the phone number of the smartphone 201 to the multifunctional service server 215 (step 12 in FIG. 5).

The multifunctional service server 215 searches for a phone number corresponding to the phone number of the smartphone 201 provided by the call process server 217 with reference to the call relay information DB 223 and afterwards, may obtain a “keyword phone number” corresponding to the searched phone number.

By referring to FIG. 7, because the phone number of the smartphone 201 provided by the call process server 217 is 010-7676-7676, the multifunctional service server 215 searches the call relay information DB 223 for a phone number corresponding to the phone number. The multifunctional service server 215 may obtain the keyword phone number of “070-1234-1234” corresponding to the phone number of “010-7676-7676” in the call relay information DB 223 (step 13 in FIG. 5).

When the multifunction service server 215 provides to the call process server 217 the “keyword phone number” obtained with reference to the call relay information DB 223 (step 14 in FIG. 5), the call process server 217 calls at the phone number 219 given to the “keyword phone number” and forwards the call to the smartphone 201 (step 15 in FIG. 5).

By referring to FIG. 7, the call process server 217 may relay a call by calling at the phone number (070-1234-1234) of Gasan branch of KyoChon F&B, the keyword phone number, obtained from the call replay information DB 223 by the multifunctional service server 215 and provided to the call process server 217, and forwarding the call to the smartphone 201.

In the above-described embodiments, the voice recognition server 11, 111, 211 are separately installed. Also, it is possible to build a voice recognition program into the smartphone. In this case, the multifunctional service application 5, 105, 205 provides voice data to the voice recognition program built into the smartphone 1, 101, 201, and the voice recognition program may generate a keyword list from the voice data. Afterwards, the keyword list generated by the voice recognition program may be provided to the multifunctional server system.

The invention has been described in relation to limited embodiments and drawings. However, it will be apparent to those skilled in the art to which the present invention pertains that other modifications and changes may be made without departing from the spirit and scope of the invention. Further, it is to be understood that the present invention should not be construed as being limited to the embodiments set forth herein. Accordingly, the scope of protection of the present invention should be determined not only by the attached claims that will be described hereunder but also by equivalents of the attached claims.

1. A voice keyword-based multifunctional service system comprising:
a smartphone into which a voice is input; and
a multifunctional server system for performing an operation of receiving voice data from the smartphone and of generating a keyword from the voice data transmitted by the smartphone,
wherein the multifunctional server system performs an operation of providing content corresponding to the keyword to the smart phone with reference to a keyword information DB—a database in which keyword information is pre-stored—, and
a multifunctional service application installed in the smart phone performs an operation of executing the content corresponding to the keyword.

2. A voice keyword-based multifunctional service system according to claim 1,
wherein the operation of generating a keyword comprises generating a keyword list from the voice data transmitted by the smartphone and selecting a keyword from the generated keyword list.

3. A voice keyword-based multifunctional service system according to claim 2,
wherein the multifunctional server system transmits to the smartphone the keyword or the keyword list generated as a result of the operation of generating a keyword,
the smartphone transmits to the multifunctional server system an multifunctional service application ID together with the keyword or the keyword list,
the multifunctional server system provides to the smartphone content corresponding to the keyword together with the multifunctional service application ID when providing to the smartphone the content corresponding to the keyword, and
the smartphone executes the multifunctional service application ID, and the multifunctional service application executes the content corresponding to the keyword.

4. A voice keyword-based multifunctional service system according to claim 1,
wherein the content corresponding to the keyword comprises at least one of phone numbers, URLs used to access web servers, program package names used to execute the programs,
the operation of executing the content corresponding to the keyword comprises executing a calling program and performing an operation, carried out by the executed calling program, Of calling a call process server having a phone number in the event that the content corresponding to the keyword is a phone number of a call process server,
the operation of executing the content corresponding to the keyword comprises executing a web browser and performing an operation, carried out by the executed web browser, of accessing a web server having a URL in the event that the content corresponding to the keyword is a URL of a web server, and
the operation of executing the content corresponding to the keyword comprises executing a program having a program package name in the event that the content corresponding to the keyword is a program package name.

5. A voice keyword-based multifunctional service system according to claim 3,
wherein the multifunctional server system generates a call relay information DB with reference to the keyword information DB, the keyword and the multifunctional service application ID.

6. A voice keyword-based multifunctional service system according to claim 5,
the multifunctional server system comprising:
a call process server,
wherein the operation of executing the content corresponding to the keyword comprises executing a calling program and performing an operation, carried out by the executed calling program, of calling the call process server having a phone number in the event that the content corresponding to the keyword is a phone number of the call process server,
the call process server transmits a phone number of the smartphone to the multifunctional server system when receiving a call from the smartphone,
the multifunctional server system obtains a phone number corresponding the phone number of the smartphone with reference to the call relay information DB to provide the obtained phone number to the call process server, and
the call process server forwards the call received from the smartphone to a place having the phone number provided by the multifunctional server system.

7. A computer-readable recording medium in which recorded is a voice keyword-based multifunctional service application for executing a method for a voice keyword-based multifunctional service,
wherein the multifunctional service application is combined with hardware provided to a smartphone and linked to a multifunctional server system to execute the method for a voice keyword-based multifunctional service,
the method for a multifunctional service comprising:
receiving a voice (step A);
converting the voice into digital data and transmitting the converted voice data to the multifunctional server system (step B);
receiving from the multifunctional server system content corresponding to a keyword generated from the voice data (step C); and
executing the content corresponding to the keyword (step D).

8. The computer-readable recording medium according to claim 7,
the method for a multifunctional service further comprising:
between the step B and the step C,
receiving a keyword or keyword list generated from the voice data; and
transmitting to the multifunctional server system a multifunctional service application ID together with the keyword and the keyword list,
wherein the step C comprises receiving content corresponding to the keyword and the multifunctional service application ID, and
the step D comprises executing the multifunctional service application and performing an operation, carried out by the multifunctional service application, of executing the content corresponding to the keyword.

9. The computer-readable recording medium according to claim 7,
wherein the content corresponding to the keyword comprises at least one of phone numbers, URLs used to access web servers, program package names used to execute the programs,
the step D comprises executing a calling program, and performing an operation, carried out by the executed calling program, of calling a call process server having a phone number in the event that the content corresponding to the keyword is a phone number of a call process server,
the step D comprises executing a web browser and performing an operation, carried out by the executed web browser, of accessing a web server having a URL in the event that the content corresponding to the keyword is a URL of a web server, and
the step D comprises executing a program having a program package name in the event that the content corresponding to the keyword is a program package name.

10. A computer-readable recording medium in which recorded is a voice keyword-based multifunctional service program for executing a method for a voice keyword-based multifunctional service,
wherein the multifunctional service program is combined with hardware provided to a multifunctional server system and linked to a smartphone to execute the method for a voice keyword-based multifunctional service,
the method for a multifunctional service comprising:
receiving voice data (step A) from a smartphone;
generating a keyword from the received voice data (step B); and
providing to the smartphone content corresponding to the keyword with reference to a keyword information DB—a database in which keyword information is pre-stored—, (step C).

11. The computer-readable recording medium according to claim 10,
the method for a multifunctional service further comprising:
between the step B and the step C,
transmitting to the smartphone a keyword or keyword list generated from the voice data; and
receiving a multifunctional service program ID together with the keyword and the keyword list,
wherein the step B comprises generating a keyword list from the voice data transmitted by the smartphone and selecting a keyword from the generated keyword list, and
the step C comprises providing to the smartphone content corresponding to the keyword together with the multifunctional service program ID.

12. The computer-readable recording medium according to claim 10,
wherein the multifunctional server system generates a call relay DB with reference to the keyword information DB, the keyword and the multifunctional service program ID.

13. The computer-readable recording medium according to claim 12,
the multifunctional server system comprising a call process server,
wherein the call process server transmits a phone number of the smartphone to the multifunctional server system when receiving a call from the smartphone,
the multifunctional server system obtains a phone number corresponding the phone number of the smartphone with reference to the call relay DB to provide the obtained phone number to the call process server, and
the call process server forwards the call received from the smartphone to a place having the phone number provided by the multifunctional server system.
